(19) United States
(12) Patent Application Publication
(10) Pub. No.: US 2015/0037158 A1
(43) Pub. Date: Feb. 5, 2015

(54) TORQUE CONVERTER WITH STAMPED STATOR

(71) Applicant: Schaeffler Technologies GmbH & Co. KG, Herzogenaurach (DE)

(72) Inventors: Markus Steinberger, Macedonia, OH (US); Jacob Rufener, Rittman, OH (US)

(73) Assignee: Schaeffler Technologies GmbH & Co. KG, Herzogenaurach (DE)

(21) Appl. No.: 14/337,935

(22) Filed: Jul. 22, 2014

Related U.S. Application Data
(60) Provisional application No. 61/860,169, filed on Jul. 30, 2013.

(51) Int. Cl. F16H 41/28

(52) U.S. Cl. CPC F16H 41/28; F16H 2041/285
USPC 416/197 C

(57) ABSTRACT

A stamped stator for a torque converter includes a first blade plate, a second blade plate, an outer race, at least one wedge plate, and an inner race. The first blade plate includes a first blade portion, a first radial wall connected to the first blade portion, a first plurality of radially inwardly extending tabs, and a second radially inwardly extending surface. The second blade plate includes a second blade portion axially aligned with the first blade portion, and a second radial wall axially aligned with the first radial wall. The outer race is disposed axially between the first and second blade plates and includes a third radial wall radially and axially aligned with the first radial wall, a fourth radial wall radially and axially aligned with the second radial wall, and an inwardly facing circumferential notch.

### FIELD

The invention relates generally to a torque converter and more specifically to a torque converter with a stamped stator.

### BACKGROUND

Torque converters with stamped stators are known. One example is shown in commonly-assigned U.S. Pat. No. 8,162,612, hereby incorporated by reference. Also, torque converters with wedge one-way clutches are known. One example is shown in commonly-assigned United States Patent Application Publication No. 2009/0159390, hereby incorporated by reference.

### BRIEF SUMMARY

Example aspects broadly comprise a stamped stator for a torque converter including a first blade plate, a second blade plate, an outer race, at least one wedge plate, and an inner race. The first blade plate includes a first blade portion, a first radial wall connected to the first blade portion, a first plurality of radially inwardly extending tabs, and a second radially inwardly extending surface. The second blade plate includes a second blade portion axially aligned with the first blade portion, and a second radial wall axially aligned with the first radial wall. The outer race is disposed axially between the first and second blade plates and includes a third radial wall radially and axially aligned with the first radial wall, a fourth radial wall radially and axially aligned with the second radial wall, and an inwardly facing circumferential notch. The at least one wedge plate is at least partially axially aligned with the first plurality of tabs and includes a radially outer portion at least partially disposed in the outer race notch and a radially inner portion with a ramped surface. The inner race includes a ramped outer surface that is complementary to and engageable with the wedge plate ramped surface, disposed radially inside of the first plurality of radially inwardly extending tabs, and at least partially axially aligned with the second radially inwardly extending surface.

In an example embodiment, the stamped stator includes a first plurality of rivets extending through respective holes in the first blade plate first radial wall, the second blade plate radial wall, and the outer race third and fourth radial walls. In an example embodiment, the stamped stator includes a first spacer ring axially aligned with and disposed between the first blade plate first radial tab and the at least one wedge plate. In some example embodiments, the first radially extending tabs and second radially extending surface are radially misaligned. In an example embodiment, the second radially extending surface is radially aligned with the first radial wall. In an example embodiment, the inner race includes a first circumferential surface radially inside of the ramped outer surface, and the first blade plate second radially extending surface includes a second circumferential surface axially and radially aligned with the first circumferential surface.

In some example embodiments, the second blade plate includes a third plurality of radially extending tabs and a fourth radially inwardly extending surface at least partially axially aligned with the inner race ramped outer surface. In an example embodiment, the stamped stator includes a second spacer ring axially aligned with and disposed between the second blade plate third radial tab and the at least one wedge plate. In an example embodiment, the third radially extending tabs and the fourth radially extending surface are radially misaligned. In some example embodiments, the inner race includes a third circumferential surface radially inside of the ramped outer surface and the second blade plate fourth radially extending surface includes a fourth circumferential surface axially and radially aligned with the third circumferential surface. In an example embodiment, the inner race includes a first circumferential surface radially inside of the ramped outer surface and the first blade plate second radially extending surface includes a second circumferential surface axially and radially aligned with the first circumferential surface. In an example embodiment, the inner race first and third circumferential surfaces are axially misaligned.

In an example embodiment, the second blade plate includes a low friction ring. In an example embodiment, the stamped stator includes a second plurality of rivets. The first and second blade plates include respective fifth and sixth axially aligned radial walls disposed radially outside of the first and second blade portions and fixed together by the second plurality of rivets. In an example embodiment, the first or second radial wall includes an axial protrusion with an inner circumferential surface radially and axially aligned with an outer circumferential surface of the outer race.

### BRIEF DESCRIPTION OF THE DRAWINGS

The nature and mode of operation of the present invention will now be more fully described in the following detailed description taken with the accompanying drawing figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a cross section view of a torque converter with stamped stator according to an example aspect;

FIG. 3 is a front view of a portion of a stator blade plate according to an example aspect;

FIG. 4 is a front view of a wedge one-way clutch assembly according to an example aspect;

FIG. 5 is a cross section view of a torque converter with stamped stator according to an example aspect; and,

FIG. 6 is a cross section view of a torque converter with stamped stator according to an example aspect.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

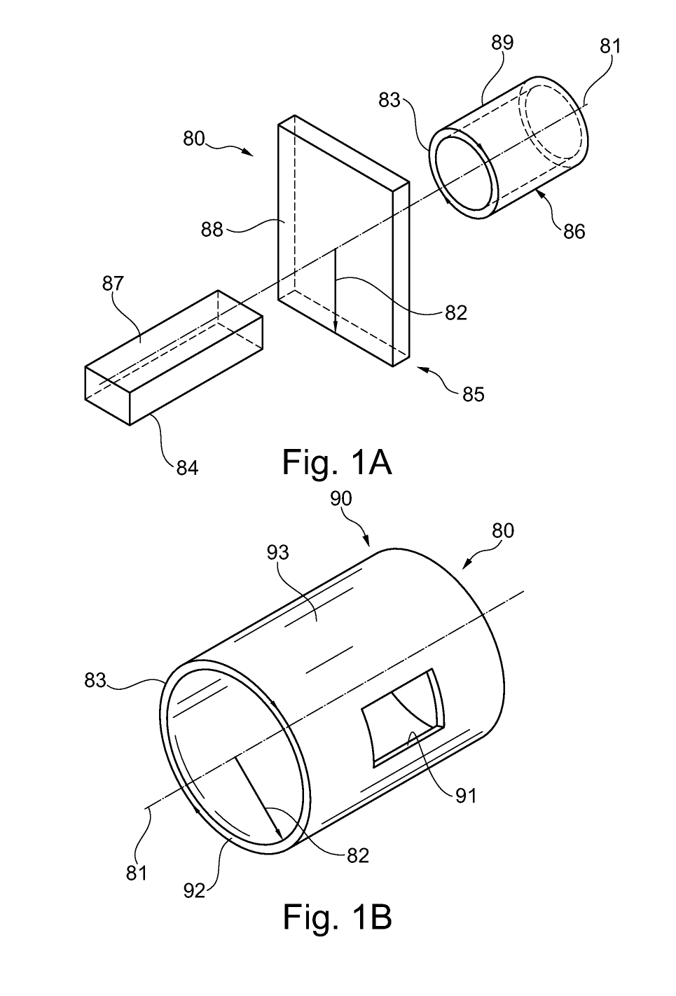

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential plane.

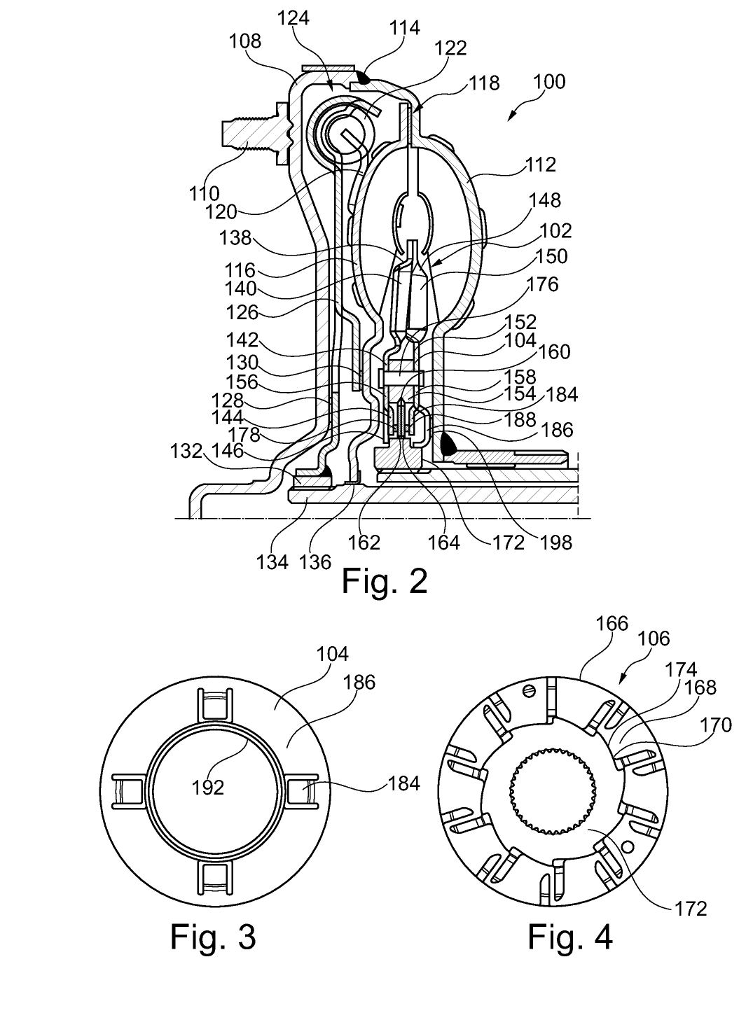

The following description is made with reference to FIGS. 2-4. FIG. 2 is a cross section view of torque converter 100 with stamped stator 102 according to an example aspect. FIG. 3 is a front view of a portion of blade plate 104 according to an example aspect. FIG. 4 is a front view of wedge one-way clutch assembly 106 according to an example aspect. Torque converter 100 includes front cover 108 with stud 110 for driving connection with an engine, for example, and impeller 112 fixed to the cover at weld 114. Turbine 116 includes clutch 118 for frictional engagement with impeller 112, and drive plate 120 for driving connection to spring 122 of damper assembly 124. Spring retainer 126 includes low friction pads 128 and 130 for thrust engagement with the front cover and the turbine, respectively, and hub 132 for driving engagement with input shaft 134. Turbine 116 is sealingly engaged with the input shaft at bushing 136.

Stamped stator 102 includes blade plate 138 with blade portion 140, radial wall 142 connected to the blade portion, radially inwardly extending tabs 144, and radially inwardly extending surface 146. Stamped stator 102 includes blade plate 148 with blade portion 150, axially aligned with blade portion 140, and radial wall 152 axially aligned with radial wall 142. Stator 102 includes outer race 154 disposed axially between blade plates 138 and 148. The outer race has radial wall 156 radially and axially aligned with radial wall 142, radial wall 158 radially and axially aligned with radial wall 152, and inwardly facing circumferential notch 160.

Stamped stator 102 includes wedge plates 162 and 164 at least partially axially aligned with tabs 142. Plates 162 and 164 include radially outer portion 166 at least partially disposed in the outer race notch and radially inner portion 168 including ramped surface 170. Stamped stator 102 includes inner race 172 with ramped outer surface 174. The outer surface is complementary to and engageable with the wedge plate ramped surface, disposed radially inside of tabs 142, and at least partially axially aligned with surface 146.

Stamped stator 102 includes rivet 176 extending through respective holes in blade plate radial wall 142, blade plate radial wall 152, and outer race radial walls 156 and 158. Stamped stator 102 includes spacer ring 178 axially aligned with and disposed between the radial tab 144 and wedge plate 162. Radially extending tab 144 and radially extending surface 146 are radially misaligned. Radially extending surface 146 is radially aligned with radial wall 156.

Blade plate 148 includes radially extending tabs 184 and radially extending surface 186 at least partially axially aligned with the inner race ramped outer surface. Stamped stator 102 includes spacer ring 188 axially aligned with and disposed between radial tab 184 and wedge plate 164. Tab 184 and surface 186 are radially misaligned. Blade plate 148 includes low friction ring 198 for limiting frictional contact with impeller 112.

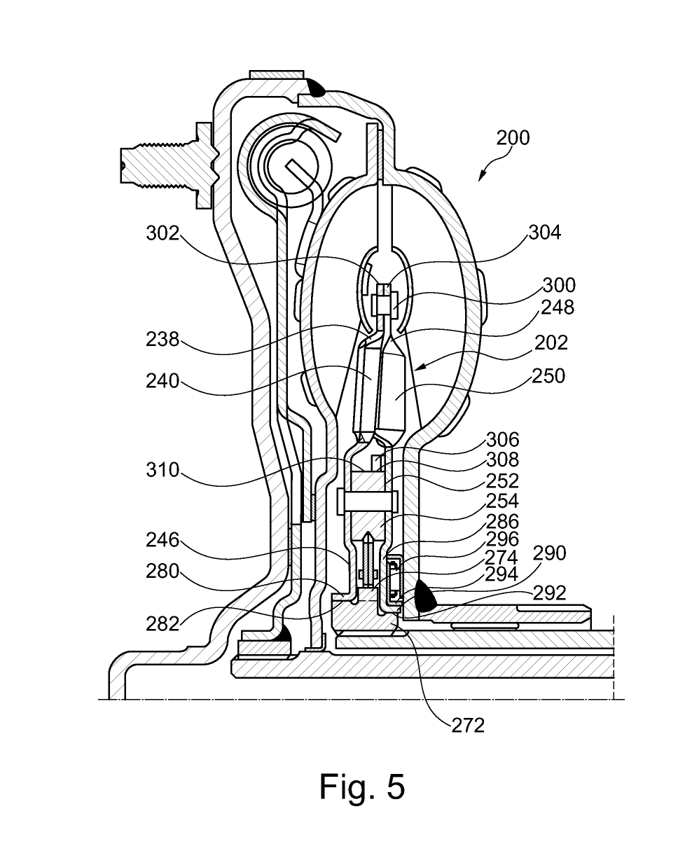

The following description is made with reference to FIG. 5. FIG. 5 is a cross section view of torque converter 200 including stamped stator 202 according to an example aspect. Inner race 272 includes circumferential surface 280 radially inside of ramped outer surface 274. Radially extending surface 246 includes portion 282 axially and radially aligned with the first circumferential surface. Inner race 272 includes circumferential surface 290 radially inside of ramped outer surface 274. Radially extending surface 286 includes circumferential surface 292 axially and radially aligned with circumferential surface 290. In an example embodiment, the blade plate includes outer circumferential surface 294 for radially positioning bearing 296. In an example embodiment, surfaces 280 and 290 are axially misaligned. Stator 202 includes rivet 300. Blade plates 238 and 248 includes respective axially aligned radial walls 302 and 304 disposed radially outside of blade portions 240 and 250, and fixed together by rivet 300. Blade plate 248 radial wall 252 includes axial protrusion 306 with inner circumferential surface 308 radially and axially aligned outer circumferential surface 310 of outer race 254.

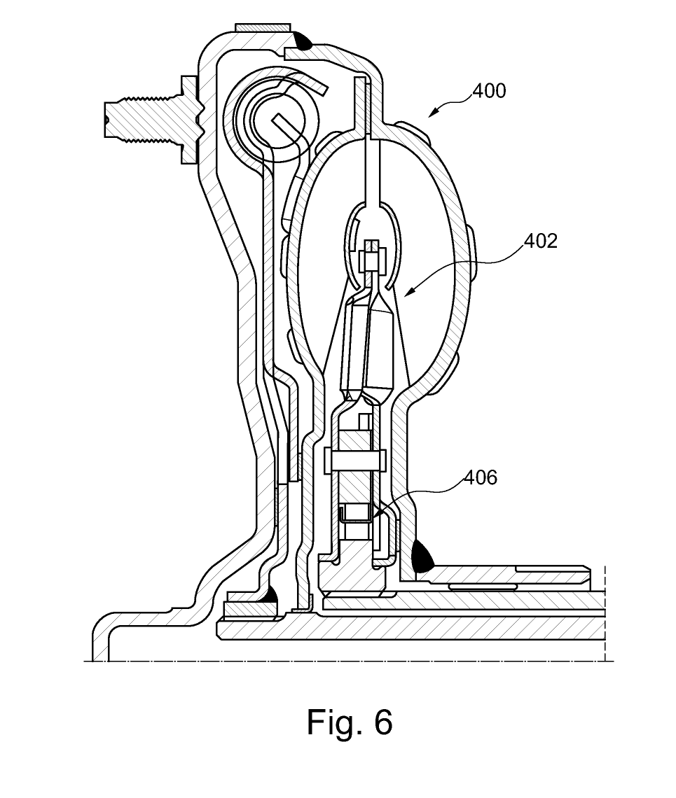

The following description is made with reference to FIG. 6. FIG. 6 is a cross section of torque converter 400 with stamped stator 402 according to an example aspect. In an example embodiment, stator 402 includes cartridge-style one-way clutch 406 in place of wedge one-way clutch 106 of torque converter 100 shown in FIG. 2.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A stamped stator for a torque converter comprising:
a first blade plate including:
a first blade portion;
a first radial wall connected to the first blade portion;
a first plurality of radially inwardly extending tabs; and,
a second radially inwardly extending surface;
a second blade plate including:
a second blade portion axially aligned with the first blade portion; and,
a second radial wall axially aligned with the first radial wall;
a outer race, disposed axially between the first and second blade plates, including:
a third radial wall radially and axially aligned with the first radial wall;
a fourth radial wall radially and axially aligned with the second radial wall; and;
an inwardly facing circumferential notch;
at least one wedge plate at least partially axially aligned with the first plurality of tabs and including:
a radially outer portion at least partially disposed in the outer race notch; and,
a radially inner portion including a ramped surface; and;
an inner race including:
a ramped outer surface:
complementary to and engageable with the wedge plate ramped surface;
disposed radially inside of the first plurality of tabs; and,
at least partially axially aligned with the second surface.

2. The stamped stator of claim 1 further comprising a first plurality of rivets extending through respective holes in the first blade plate first radial wall, the second blade plate radial wall, and the outer race third and fourth radial walls.

3. The stamped stator of claim 1 further comprising a first spacer ring axially aligned with and disposed between the first blade plate first radial tab and the at least one wedge plate.

4. The stamped stator of claim 1 wherein the first radially extending tabs and the second radially extending surface are radially misaligned.

5. The stamped stator of claim 4 wherein the second radially extending surface is radially aligned with the first radial wall.

6. The stamped stator of claim 1 wherein:
the inner race includes a first circumferential surface radially inside of the ramped outer surface; and,
the first blade plate second radially extending surface includes a second circumferential surface axially and radially aligned with the first circumferential surface.

7. The stamped stator of claim 1 wherein the second blade plate comprises:
a third plurality of radially extending tabs; and,
a fourth radially inwardly extending surface at least partially axially aligned with the inner race ramped outer surface.

8. The stamped stator of claim 7 further comprising a second spacer ring axially aligned with and disposed between the second blade plate third radial tab and the at least one wedge plate.

9. The stamped stator of claim 7 wherein the third radially extending tabs and the fourth radially extending surface are radially misaligned.

10. The stamped stator of claim 7 wherein:
the inner race includes a third circumferential surface radially inside of the ramped outer surface; and,
the second blade plate fourth radially extending surface include a fourth circumferential surface axially and radially aligned with the third circumferential surface.

11. The stamped stator of claim 10 wherein:
the inner race includes a first circumferential surface radially inside of the ramped outer surface; and,
the first blade plate second radially extending surface includes a second circumferential surface axially and radially aligned with the first circumferential surface.

12. The stamped stator of claim 11 wherein the inner race first and third circumferential surfaces are axially misaligned.

13. The stamped stator of claim 1 wherein the second blade plate includes a low friction ring.

14. The stamped stator of claim 1 further comprising a second plurality of rivets, wherein the first and second blade plates comprise respective fifth and sixth axially aligned radial walls disposed radially outside of the first and second blade portions and fixed together by the second plurality of rivets.

15. The stamped stator of claim 1 wherein the first or second radial wall includes an axial protrusion with an inner circumferential surface radially and axially aligned with an outer circumferential surface of the outer race.
